(19) United States
(12) Patent Application Publication
(10) Pub. No.: US 2013/0092097 A1
(43) Pub. Date: Apr. 18, 2013

(54) PLAY TOYS AND TECHNIQUES FOR FABRICATING PLAY TOYS

(71) Applicant: John Scott Cooper, Ft. Lauderdale, FL (US)

(72) Inventor: John Scott Cooper, Ft. Lauderdale, FL (US)

(21) Appl. No.: 13/646,322

(22) Filed: Oct. 5, 2012

Related U.S. Application Data
(60) Provisional application No. 61/543,441, filed on Oct. 5, 2011.

(51) Int. Cl. A01K 15/02; G09F 3/00

(52) U.S. Cl. CPC A01K 15/025; G09F 3/00
USPC 119/707; 40/299.01

(57) ABSTRACT

A play toy has a series of play objects and a connecting member connecting the play objects together for undergoing translation and rotary movement relative to the connecting member and to one another.

### BACKGROUND OF THE INVENTION

1. Field of the Invention

The present invention relates generally to the field of play toys. More specifically, the invention relates to play toys for animals that incorporate play objects independently movable relative one another.

2. Background Information

It is desirable to provide pets and, in particular, dogs, with play toys that will entertain the dogs and occupy the dogs' attention for extended periods of time. This has been necessary in order to keep the dogs mentally engaged and interested in its environment, as well as allow for creative downtime. It is also desirable to provide play toys for pets that are easily carried and manipulated by pets, and are long-lasting, safe and non-hazardous to play with.

Generally, play toys for dogs include chew, fetch, and tug types or combinations thereof. However, existing play toys of these types have not exhibited the requisite durability and the ability to entertain and keep dogs engaged for extended periods of time.

### SUMMARY OF THE INVENTION

Play toys and techniques for fabricating play toys incorporating play objects independently movable relative one another, are described herein.

In one aspect, the present invention provides a play toy comprising a plurality of connected play objects and connecting means for connecting the play objects together for undergoing translation and rotary movement relative to one another.

In one embodiment, the connecting means comprises a connecting member extending through central through-holes of the play objects and connecting the play objects together for undergoing translation and rotary movement relative to the connecting member and to one another. In another embodiment, the play objects are made of thermoplastic rubber and the connecting member is a braided rope.

In another aspect, the present invention provides a play toy comprising a plurality of play objects and a connecting member connecting the play objects together for undergoing translation and rotary movement relative to the connecting member and to one another, two of the play objects being movably mounted to respective oppositely disposed looped portions of the connecting member and at least one of the play objects being movably mounted to a generally central portion of the connecting member disposed between the looped portions.

In yet another aspect, the present invention provides an advertising device comprising a play toy according to any of the foregoing aspects, and advertising indicia disposed at least on one of the play objects and the connecting member of the play toy.

In exemplary designs, the inventive techniques are used for fabricating chew, fetch, and tug types of pet toys or combinations thereof, as well as play toys suitable for use by various type of animals, such as dogs. Various aspects and embodiments of the invention are described in further detail below.

The foregoing summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

The foregoing summary, as well as the following detailed description of the preferred embodiments of the invention, will be better understood when read in conjunction with the accompanying drawings. For the purpose of illustrating the invention, there is shown in the drawings embodiments which are presently preferred. It should be understood, however, that the invention is not limited to the precise arrangement and instrumentalities shown. In the drawings:

FIG. 1 is a perspective view of a play toy according to a first embodiment of the present invention;

FIG. 2 is an exploded view of the play toy shown in FIG. 1;

FIG. 3 is a partial cross-sectional view of the play toy shown in FIG. 1;

FIG. 4 is a perspective view of a play toy according to a second embodiment of the present invention;

FIG. 5 is an exploded view of the play toy shown in FIG. 4;

FIG. 6 is a partial cross-sectional view of the play toy shown in FIG. 4;

FIG. 7 is a top view of a play toy according to a third embodiment of the present invention;

FIG. 8 is a top view of a play toy according to a fourth embodiment of the present invention;

FIG. 9 is a top view of a play toy according to a fifth embodiment of the present invention; and

FIG. 10 is a top view of a play toy according to a sixth embodiment of the present invention.

### DETAILED DESCRIPTION OF THE PREFERRED EMBODIMENTS

The images in the drawings are simplified for illustrative purposes and are not depicted to scale. To facilitate understanding, identical reference numerals have been used, where possible, to designate identical elements that are common to the figures, except that suffixes may be added, when appropriate, to differentiate such elements.

The appended drawings illustrate exemplary embodiments of the invention and, as such, should not be considered as limiting the scope of the invention that may admit to other equally effective embodiments. It is contemplated that features or steps of one embodiment may be beneficially incorporated in other embodiments without further recitation.

The term “exemplary” is used herein to mean “serving as an example, instance, or illustration.” Any embodiment or design described herein as “exemplary” or “alternative” is not necessarily to be construed as preferred or advantageous over other embodiments or designs.

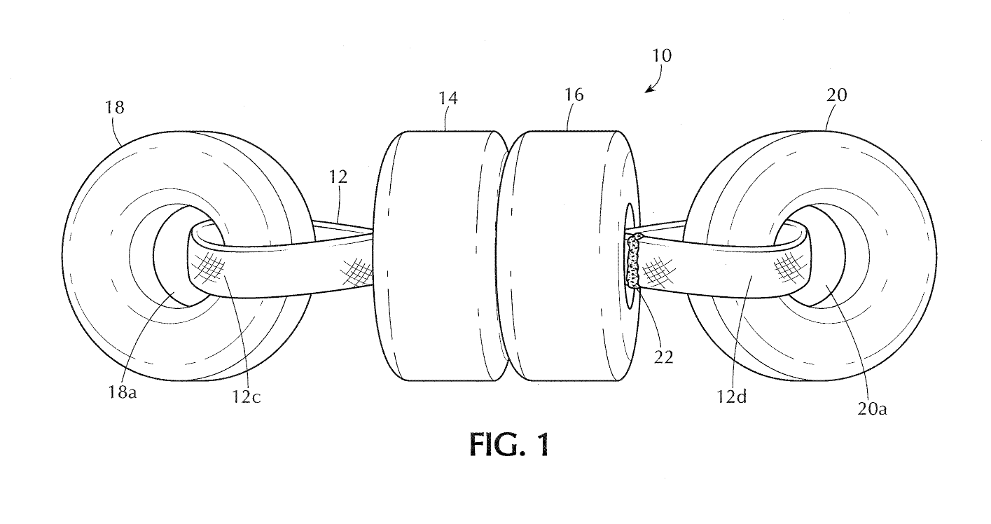

FIGS. 1-3 show a play toy, generally designated at 10, according to a first embodiment of the present invention. Play toy 10 includes a series of rotary play objects or members in the form of wheels 14, 16, 18, 20 having central through-holes 14a, 16a, 18a, 20a, respectively, and connecting means for connecting wheels 14, 16, 18, 20 together for undergoing translation and rotary movement relative to one another.

In the present embodiment, the connecting means comprises a connecting member 12 that extends through central through-holes 14a, 16a, 18a, 20a and connects wheels 14, 16, 18, together for undergoing translation and rotary movement relative to connecting member 12 and to one another. In this embodiment, four wheels are movably mounted on connecting member 12, with wheels 18, 20 being disposed on opposite sides of wheels 14, 16 which are centrally located relative to wheels 18, 20. Wheels 14, 16 are mounted on connecting member 12 so as to be in abutting relation to one another.

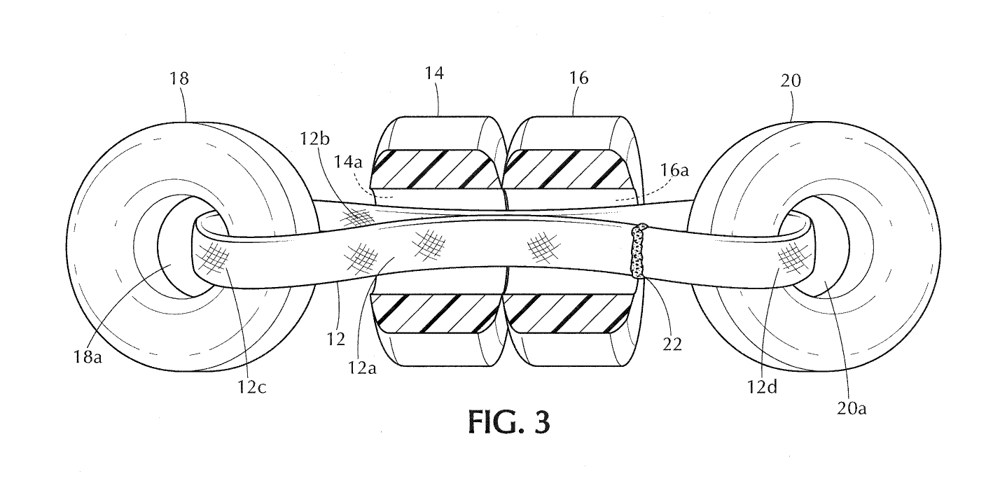

Each wheel 14, 16, 18, 20 is preferably made of a durable rubber material, such as thermoplastic rubber (TPR). Connecting member 12 may also be made of a durable rubber material, such as TPR. Alternatively, connecting member 12 may be a braided rope formed of a durable, high strength material, such as nylon. The dimensions (e.g., thickness, width, diameter, etc.) of connecting member 12 are selected so that in the mounted state wheels 14, 16, 18, 20 are capable of undergoing translation and rotary movement relative to connecting member 12 and to one another. In the present embodiment, this is accomplished by providing through-holes 14a, 16a, 18a, 20a of wheels 14, 16, 18, 20, respectively, with diameters that are greater in dimension than corresponding width/thickness dimensions of connecting member 12, as shown in FIGS. 1 and 3.

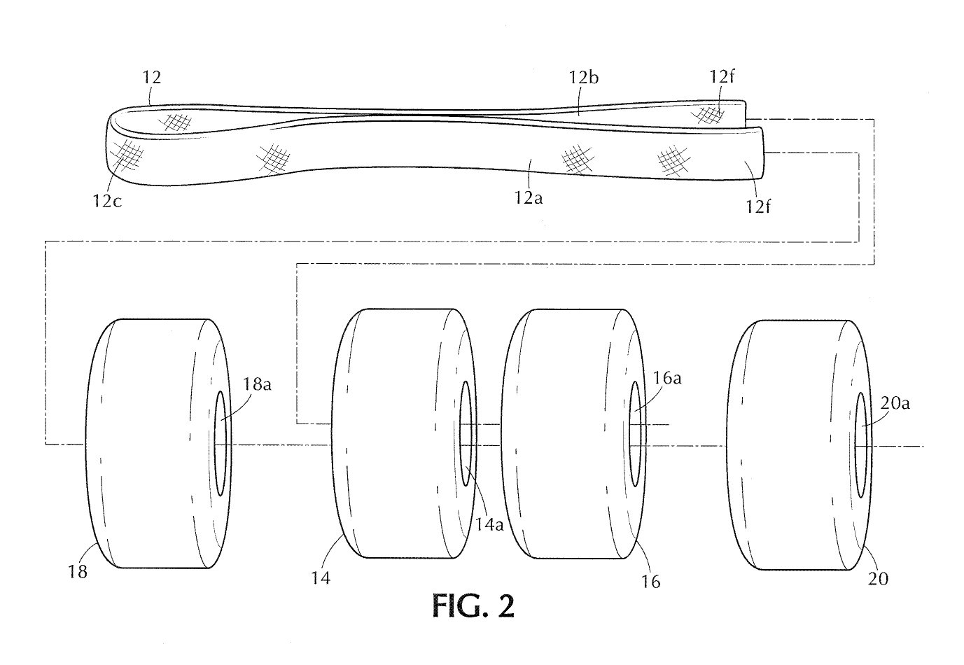

FIG. 2 is an exploded view and FIG. 3 is a partial cross-sectional view of play toy 10. Connecting member 12 is preferably made of a single piece of material which, when folded as shown in FIG. 2, forms two long portions 12a, 12b each with a free end portion 12f (right end portions in FIG. 2) and a first looped end portion 12c (left end portion in FIG. 2) interconnecting long portions 12a, 12b. Free end portions 12f are securely connected together as denoted at 22 in FIGS. 1 and 3 by suitable securing means, such as by stitching and/or a suitable adhesive depending on the type of material used for connecting member 12, to thereby form connecting member 12 into a continuous, closed loop configuration. By connecting free end portions 12f in this manner, a second looped end portion 12d is provided (right end portion in FIGS. 1 and 3).

Referring to FIGS. 2 and 3, assembly of the play toy 10 may be accomplished by first passing one end portion 12f of connecting member 12 through through-hole 18a of wheel 18 so that connecting member 12 encircles or loops around wheel 18 (i.e., via looped end portion 12c). Then, with long portions 12a, 12b of connecting member 12 disposed generally parallel to one another (e.g., as shown in FIG. 2), long portions 12a, 12b are passed through through-hole 14a of wheel 14 and through-hole 16a of wheel 16 while leading with respective free end portions 12f. One free end portion 12f of connecting member 12 is then passed through through-hole 20a of wheel 20 and thereafter securely connected to the other free end portion 12f at 22 as described above. By this assembly method, the assembled state of play toy 10 shown in FIG. 1 is achieved. It will be understood that the assembled state of play toy 10 can also be achieved by first passing end portion 12f of connecting member 12 through through-hole 20a of wheel 20 and then passing the end portion 12f through through-hole 18a of wheel 18 after long portions 12a, 12b are passed through through-holes of 14a, 16a of wheels 14, 16, respectively, and thereafter securely connecting free end portion 12f to the other free end portion 12f as denoted at 22 as described above.

In the assembled state of the play toy 10 shown in FIGS. 1 and 3, both long end portions 12a, 12b of connecting member 12 extend through through-holes 14a, 16a of wheels 14, 16, respectively, first looped end portion 12c is looped around or encircles wheel 18 via through-hole 18a, and second looped end portion 12d is looped around or encircles wheel 20 via through-hole 20a. By this construction, wheels 14, 16, 18, 20 are permitted to independently rotate relative to connecting member 12, for example, wheels 14, 16 can independently rotate about long end portions 12a, 12b and wheels 18, 20 can independently rotate about portions of connecting member 12 forming first and second looped end portions 12c 12d, respectively. At the same time, wheels 14, 16, 18, 20 are permitted to independently translate relative to connecting member 12, for example, wheels 14, 16 can independently translate or slide along long end portions 12a, 12b and wheels 18, 20 can independently translate or slide within first and second looped end portions 12c, 12d, respectively. This construction and positional arrangement of the components of play toy 10, including the capability of wheels 14, 16, 18, 20 to undergo independent rotation and translation movement relative to connecting member 12 and to one another, as well as the durable nature of the materials for the components of play toy 10, provide for enhanced amusement and interest to the user for extended periods of time.

It will be appreciated that by encircling wheel 18 with the first looped end portion 12c and encircling wheel 20 with second looped end portion 12d so as to permit relative movement (e.g., rotation and translation movement) between wheels 18, 20 and connecting member 12 as set forth above, wheels 18, 20 can be positioned relative to wheels 14, 16 within a range of positions ranging from perpendicular and parallel positions. More specifically, in FIG. 1 wheels 18, 20 are shown to be disposed nearly perpendicular relative to respective main surfaces of wheels 14, 16. Wheels 18, 20 are free to be displaced (i.e. turn or rotate) so they are generally parallel to the respective main surfaces of wheels 14, 16 (i.e., in a manner similar positions of wheels 18, 20 shown in FIG. 2).

In the embodiment shown in FIGS. 1-3, play objects 14, 16, 18, 20 are preferably made of a rubber material, such as TPR, however, they are not limited to being made of such material. For example, play objects 14, 16, 18, 20 may include one or more pre-formed figures made of a plastic or fabric material. Furthermore, while play objects 14, 16, 18, 20 shown in FIGS. 1-3 are generally annular-shaped in the form of wheels, other types of shapes are suitable for these play objects, including spherical-, cubic-, cylindrical-, oval-shaped, so long as the play objects are permitted to undergo rotation and translation movement relative to connecting member 12 and to one another, as described above.

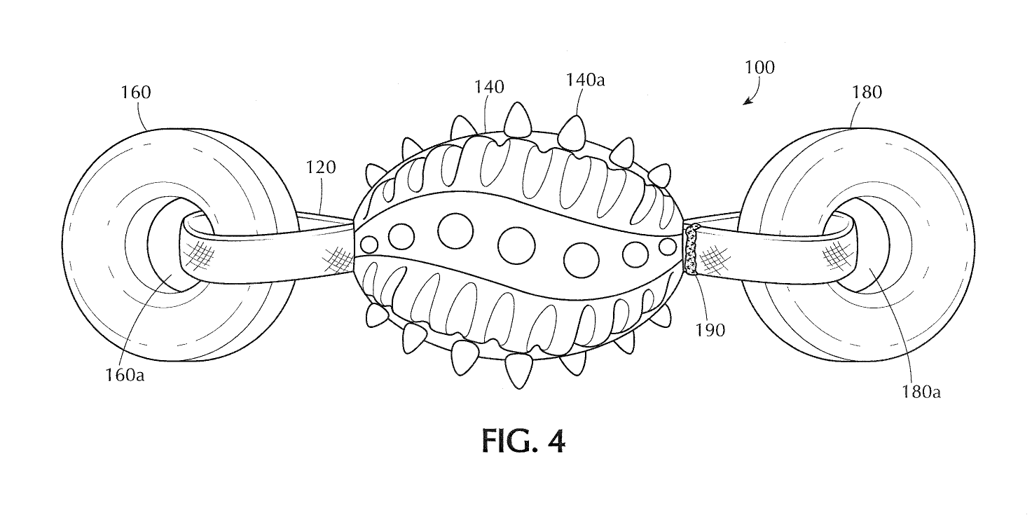

FIGS. 4-6 show a second embodiment of a play toy, generally designated at 100, according to the present invention.

The construction and materials for play toy 100 are the same as described above for play toy 10 in FIGS. 1-3, except that wheels 14, 16 are replaced by a single rotary play object or member 140. Wheels 160, 180, which include through-holes 160a, 180a, respectively, are disposed on opposite sides of play object 140 and are identical in construction to wheels 18, 20 in FIGS. 1-3. Play object 140 and wheels 160, 180 are movably mounted on a connecting member, denoted by numeral 120 in FIGS. 4-6, for undergoing translation and rotary movement relative to connecting member 120 and to one another.

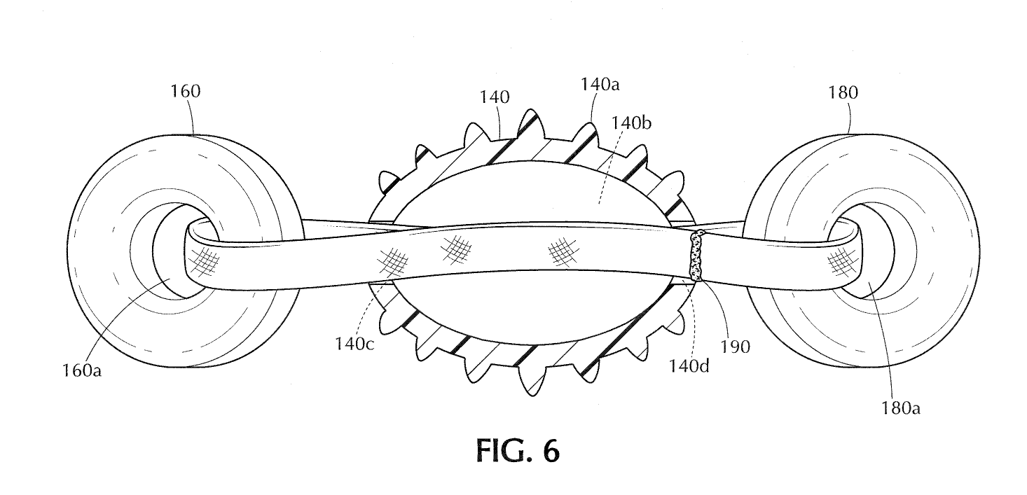

Play object 140 comprises a generally oval-shaped tubular body with an interior space 140b and oppositely aligned openings 140c, 140d through which the long portions of connecting member 120 extend via interior space 140b, as shown in FIG. 6. The openings 140c, 140d are dimensioned so as to permit rotation and translation movement of tubular body 140 relative to connecting member 120. Additionally, tubular body 140 is formed with bump-like elements 140a protruding from an outer surface thereof.

Play objects 140, 160, 180 are preferably made of a durable rubber material, such as thermoplastic rubber (TPR). Connecting member 120 has the same construction as connecting member 12 described above with reference to FIGS. 1-4 and is also preferably made of a durable rubber material, such as TPR. Alternatively, connecting member 120 may be a braided rope formed of a durable, high strength material, such as nylon.

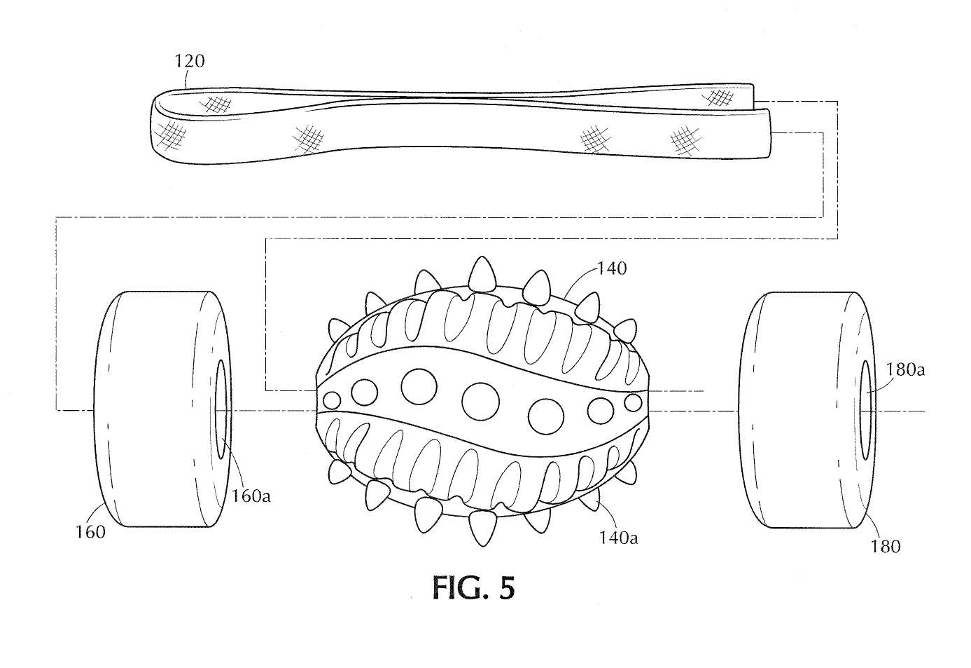

FIG. 5 is an exploded view and FIG. 6 is a partial cross-sectional view of the play toy 100. With reference to these figures, assembly of play toy 100 is accomplished in a manner similar as described above for play toy 10 in FIGS. 1-3. However, rather than being passed through the through-holes of wheels 14, 16, the long portions of connecting member 120 are passed through openings 140c, 140d of connecting member 140 via interior space 140b. After mounting wheels 160, 180 on connecting member 120 as described above for wheels 18, 20 in the embodiment of FIGS. 1-3, connecting member 120 is formed into a continuous, closed loop configuration by securing as shown at 190 via suitable securing means, such as by stitching and/or a suitable adhesive depending on the type of material used for connecting member 120, thereby completing assembly of play toy 100.

In the assembled state of play toy 100 shown in FIGS. 4 and 6, both long end portions of connecting member 120 extend through openings 140c, 140d via interior space 140b, the first looped end portion (looped end portion at left side of connecting member 120 in FIG. 6) is looped around or encircles wheel 160 via through-hole 160a, and the second looped end portion (looped end portion at right side of connecting member 120 in FIG. 6) is looped around or encircles wheel 180 via through-hole 180a. By this construction, tubular body 140 and wheels 160, 180 are permitted to independently rotate relative to connecting member 120, for example, tubular body 140 can independently rotate about long end portions of connecting member 120 and wheels 160, 180 can independently rotate about portions of connecting member 120 forming first and second looped end portions, respectively. At the same time, tubular body 140 and wheels 160, 180 are permitted to independently translate or slide relative to connecting member 120, for example, tubular body 140 can independently translate or slide along long end portions of connecting member 120 and wheels 160, 180 can independently translate or slide within first and second looped end portions, respectively, of connecting member 120. This construction and positional arrangement of play objects 140, 160, 180, including the capability of tubular body 140 and wheels 160, 180 to undergo independent rotational and transnational movements relative to connecting member 120 and to one another, as well as the durable nature of the materials for the play object of play toy 100, provides for enhanced amusement and interest to the user for extended periods of time.

In the embodiment of FIGS. 4-6, play objects 140, 160 and 180 are preferably made of a rubber material, such as TPR, however, they are not limited to being made of such material. For example, play objects 140, 160, 180 may include one or more pre-formed figures made of a plastic or fabric material. Furthermore, while play object 140 is generally oval-shaped and play objects 160, 180 are generally annular-shaped in the form of wheels, other types of shapes are suitable for the these play objects, including spherical-, cubic-, and cylindrical-shaped, so long as the play objects are permitted to undergo rotation and translation movement relative to connecting member 120 and to one another, as described above.

It will be appreciated that various modifications can be made to the above-described play toys without departing from the spirit and scope of the invention, as exemplified by the modified embodiments described below.

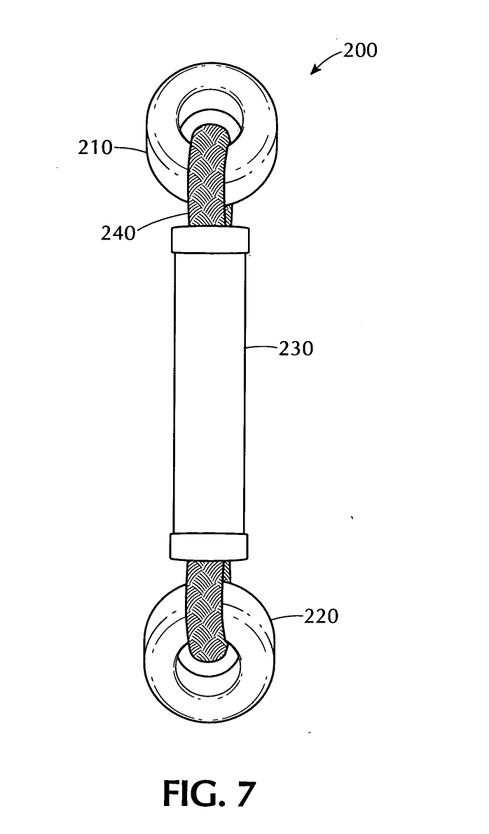

FIG. 7 is a top view of a play toy, generally designated at 200, according to a third embodiment of the present invention. Play toy 200 includes play objects 210, 220, 230 connected together via a connecting member 240. Play toy 200 has the same construction as described above for the embodiment of FIGS. 4-6, except that the play object 140 in FIGS. 4-6 is replaced with the play object 230 of generally cylindrical shape. Preferably, play objects 210, 220 and 230 are made of a durable rubber material, such as TPR, and the connecting member 240 is a braided rope. Play objects 210, 220 and 230 are mounted on braided rope 240 for undergoing rotation and translation movement relative to one another and to braided rope 240 as set forth above for the play objects in the embodiment of FIGS. 4-6.

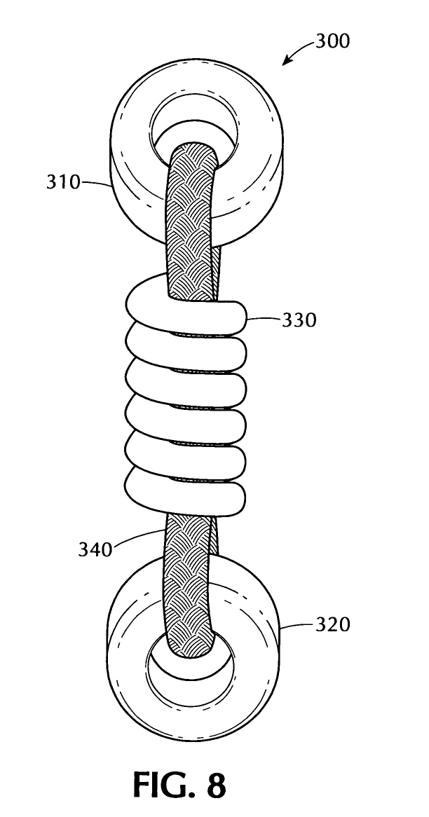

FIG. 8 is a top view of a play toy, generally designated at 300, according to a fourth embodiment of the present invention. Play toy 300 includes play objects 310, 320, 330 connected together via a connecting member 340. Play toy 200 has the same construction as described above for the embodiment of FIGS. 4-6, except that the play object 140 in FIGS. 4-6 is replaced with the play object 330 of having a coiled shape. Preferably play objects 310, 320 and 330 are made of a durable rubber material, such as TPR, and the connecting member 340 is a braided rope. Play objects 310, 320 and 330 are mounted on braided rope 340 for undergoing rotation and translation movement relative to one another and to braided rope 340 as set forth above for the play objects in the embodiment of FIGS. 4-6.

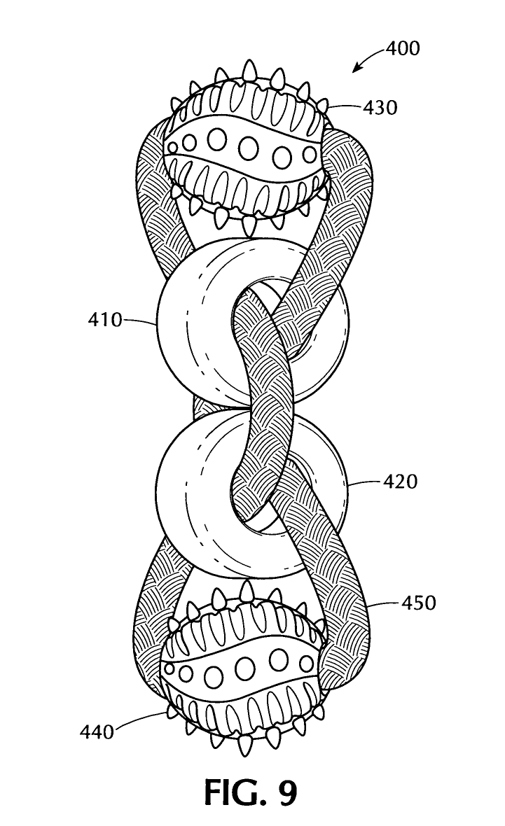

FIG. 9 is a top view of a play toy, generally designated at 400, according to a fifth embodiment of the present invention. Play toy 400 includes play objects 410, 420, 430, 440 connected together via a connecting member 450. In this embodiment, connecting member 450 is a braided rope that extends through corresponding openings and through-holes of play objects 410, 420, 430, 440 in an alternating fashion, as shown in FIG. 9, to permit the play objects to rotate relative one another and relative to braided rope 450. Further, in this embodiment, play objects 410, 420 are in the form of wheels, as described above for wheels 14, 16 in the embodiment of FIGS. 1-3, and play objects 430, 440 are generally spherical-shaped bodies. Additionally, the outer surface of the play objects 430, 440 may have some type of texture, such as bump-like elements protruding from the outer surface (as shown), or have a smooth surface. Play objects 410-440 are also preferably made of a durable rubber material, such as TPR.

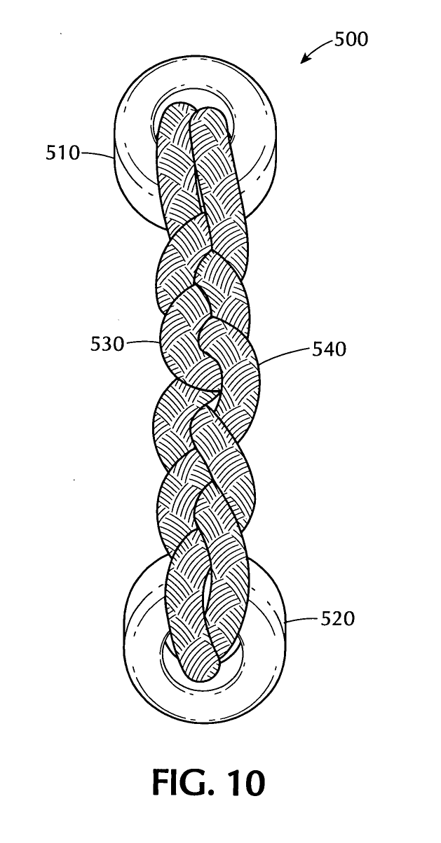

FIG. 10 is a top view of a play toy, generally designated at 500, according to a sixth embodiment of the present invention. Play toy 500 includes play objects 510, 520 connected together via a braided body formed by two braided connecting members 530, 540. In this embodiment, each connecting member 530, 540 is a braided rope braided together to form the braided rope body. Each braided rope connects to each play object 510, 520 in the same manner as connecting member 12 connects to each play object 18, 20 in the embodiment described above with reference to FIGS. 1-3. Play objects 510, 520 are preferably made of a durable rubber material, such as TPR.

A difference between play toy 500 and the play toy of the foregoing embodiments is that a rubber (e.g., TPR) play object is not provided between play objects 510, 520. Instead, play objects 510, 520 are entirely separated or spaced-apart from each other by the braided rope body. By this construction, the braided rope body provides a large biting surface for animal pets, such as dogs, during play. In this regard, it will be appreciated that the rope material (e.g., nylon rope) forming the braided body of play toy 500 cleans and flosses the teeth of the pet during repeated chewing and gnawing on the play toy while movable (e.g., rotating) play objects 510, 520 maintains the pet's interest. Thus, as the pet plays with the play toy 500 for extended periods of time and tries to rotate play objects 510, 520 relative to one another and to the braided rope body by biting down on the braided rope material, a teeth cleaning effect is achieved that is beneficial to the pet's oral health as it strengthens and exercises the pet's teeth and jaws. The biting (chewing and gnawing) action tends to scrape tartar, plaque, and debris from the pet's teeth. Thus, the incorporation of play objects that undergo movement (e.g., rotation) relative to one another and to the braided rope body in the play toy 500 according to the present invention effectively maintains the pet's interest in playing with the play toy for extended periods of time, thereby enhancing the teeth cleaning benefit provided by the braided rope material.

In the foregoing embodiments shown in FIGS. 1-10, one or more of the play objects and connecting members may have pre-selected color patterns or insignia. Coloring of the respective play objects and connecting members may be obtained by various known printing/coloring techniques.

The play toys according to the present invention are suitable for pets for playing fetch and pulling, such as dogs. Such play toys may also be scaled to accommodate pets of different age or size. By providing a series of play objects that are independently movable relative one another and relative to its connecting member, the play toys according to the present invention effectively maximize the visual and tactile stimulation provided by playing with such play toys. With such configuration, the play toys according to the present invention effectively entertain and keep the pets, such as dogs, engaged for extended periods of time.

Although described above with a specific application to a play toy for pets, the play toy of the present invention is also applicable as an advertising device. For example, one or more of the play objects and connecting members in play toys 10 and 100 described above with reference to FIGS. 1-3 and 4-6, respectively, can be imprinted or embroidered with decorative designs or advertising indicia, such as a company name or logo, an advertising message, by using, for example, a printing or an embroidering process prior or subsequent to assembly of the play toy. Alternatively, instead of imprinting or embroiding indicia, one or more decals containing indicia may be attached to one or more of the foregoing play objects and connecting members. The visual representations add desired decorative and aesthetic effects to the play toys for attracting attention, which is particularly advantageous when the play toys are used as an advertising or promotional item.

The previous description of the invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to be limited to the examples described herein but is to be accorded the widest scope consistent with the principles and novel features disclosed herein.

What is claimed is:

1. A play toy comprising: a plurality of connected play objects; and connecting means for connecting the play objects together for undergoing translation and rotary movement relative to one another.

2. A play toy according to claim 1; wherein the connecting means comprises a connecting member extending through central through-holes of the play objects and connecting the play objects together for undergoing translation and rotary movement relative to the connecting member and to one another.

3. A play toy according to claim 2; wherein the play objects comprises a plurality of wheels.

4. A play toy according to claim 3; wherein two of the plurality of wheels are disposed in abutting relation with the connecting member extending through the central through-holes thereof.

5. A play toy according to claim 2; wherein the play objects comprise a pair of wheels and a tubular body disposed between the pair of wheels and having a configuration different from that of the wheels.

6. A play toy according to claim 2; wherein the play objects are made of thermoplastic rubber.

7. A play toy according to claim 6; wherein the connecting member comprises braided rope.

8. A play toy according to claim 1; wherein the play objects are made of thermoplastic rubber.

9. A play toy comprising:
a plurality of play objects; and
a connecting member connecting the play objects together for undergoing translation and rotary movement relative to the connecting member and to one another, two of the play objects being movably mounted to respective oppositely disposed looped portions of the connecting member and at least one of the play objects being movably mounted to a generally central portion of the connecting member disposed between the looped portions.

10. A play toy according to claim 9; wherein the least one play object comprises a single play object having a tubular body with oppositely aligned openings through which the generally central portion of the connecting member extends.

11. A play toy according to claim 9; wherein the at least one of the play objects comprises two play objects identical in construction to the two play objects mounted on respective looped portions of the connecting member.

12. A play toy according to claim 9; wherein the plurality of play objects are made of thermoplastic rubber.

13. A play toy according to claim 12; wherein the connecting member comprises braided rope.

14. A play toy according to claim 9; wherein each of plurality of play objects and the connecting member is made of thermoplastic rubber.

15. An advertising device comprising: a play toy according to claim 1; and advertising indicia disposed at least on one of the play objects and connecting means of the play toy.

16. An advertising device comprising: a play toy according to claim 9; and advertising indicia disposed at least on one of the play objects and the connecting member of the play toy.
